(19) United States
(12) Patent Application Publication
(10) Pub. No.: US 2011/0239047 A1
(43) Pub. Date: Sep. 29, 2011

(54) Circuit operation verification system and verification environment creation method

(75) Inventor: Mitsunori Suwa, Kanagawa (JP)

(73) Assignee: RENESAS ELECTRONICS CORPORATION, Kawasaki-shi (JP)

(21) Appl. No.: 13/064,357

(22) Filed: Mar. 21, 2011

(30) Foreign Application Priority Data
Mar. 24, 2010 (JP) 2010-068732

(51) Int. Cl. G06F 11/00

(52) U.S. Cl. 714/32; 714/E11.02

(57) ABSTRACT

A circuit operation verification system has: a computer; a programmable logic device in which a device under test is configured; and a test bench section configured to perform operation verification of the device under test. The test bench section has: a software section that is implemented by the computer executing software; and a hardware section configured in the programmable logic device together with the device under test. The hardware section has a hardware function that generates a test pattern and inputs the test pattern to the device under test to perform the operation verification. The hardware function is controllable by changing a control parameter, and the software section variably sets the control parameter.

### INCORPORATION BY REFERENCE

This application is based upon and claims the benefit of priority from Japanese patent application No. 2010-068732, filed on Mar. 24, 2010, the disclosure of which is incorporated herein in its entirety by reference.

### BACKGROUND OF THE INVENTION

1. Field of the Invention

The present invention relates to a technique of performing operation verification of a semiconductor integrated circuit.

2. Description of Related Art

A test bench is generally used for performing operation verification (logic verification) of a semiconductor integrated circuit. A device that is a target of the operation verification is hereinafter referred to as a “DUT (Device Under Test)”. As the DUT has become larger in size and more complicated, development of the test bench has become more difficult.

Meanwhile, “random verification” is known as a kind of the operation verification. In the random verification, the DUT is supplied with a random test pattern and thereby the operation verification is performed exhaustively. In order to achieve sufficient coverage in the random verification, it is necessary to supply an enormous number of random test patterns to the DUT. It is therefore important to develop a test bench that is capable of executing the operation verification at high speed.

According to Patent Literature 1 (Japanese Patent Publication JP-2006-79417), a test bench section is constructed on a simulator. On the other hand, a DUT is implemented by a hardware emulator on a FPGA (Field Programmable Gate Array). A test pattern and a clock signal are supplied from the test bench section on the simulator to the DUT on the FPGA.

According to Patent Literature 2 (Japanese Patent Publication JP-2005-251216), an analysis of a test bench description structure is performed, and all of the test bench function is implemented by a hardware emulator.

### SUMMARY

The inventor of the present application has recognized the following points. According to the above-mentioned Patent Literature 1, the test pattern and the clock signal are supplied from the test bench section on the simulator to the DUT on the FPGA. In this case, a simulation time in the test bench section itself and a data communication time between the simulator and the FPGA are bottlenecks. Thus, it is hard to speed up the operation verification.

According to the above-mentioned Patent Literature 2, all of the test bench function is implemented by the hardware emulator. In this case, verification conditions such as the test pattern and scenario are fixed, which deteriorates flexibility of the operation verification. In order to change the verification conditions, generation and analysis of the test bench description structure must be started all over again, which requires much time.

In an aspect of the present invention, a circuit operation verification system is provided. The circuit operation verification system has: a computer; a programmable logic device in which a device under test is configured; and a test bench section configured to perform operation verification of the device under test. The test bench section has: a software section that is implemented by the computer executing software; and a hardware section configured in the programmable logic device together with the device under test. The hardware section has a hardware function that generates a test pattern and inputs the test pattern to the device under test to perform the operation verification. The hardware function is controllable by changing a control parameter. The software section variably sets the control parameter.

In another aspect of the present invention, a verification environment creation method for creating an environment for operation verification of a device under test is provided. The verification environment creation method includes: (A) reading a scenario data indicating a scenario of the operation verification from a memory device. The scenario is described in a programming language and includes a function representing contents of the operation verification. The function and associated hardware are defined in a database. The verification environment creation method further includes: (B) analyzing the scenario while referring to the database to divide functions of the operation verification into a software function implemented by software and a hardware function implemented by hardware. The hardware function generates a test pattern and inputs the test pattern to the device under test to perform the operation verification. The hardware function is controllable by changing a control parameter. The software function variably sets the control parameter. The verification environment creation method further includes: (C) generating a software execution data that is executed by a computer to provide the software function; and (D) generating a configuration data that configures the hardware function and the device under test in a programmable logic device.

In still another aspect of the present invention, a circuit operation verification method for performing operation verification of a device under test is provided. The circuit operation verification method includes: (a) reading a scenario data indicating a scenario of the operation verification from a memory device. The scenario is described in a programming language and includes a function representing contents of the operation verification. The function and associated hardware are defined in a database. The circuit operation verification method further includes: (b) analyzing the scenario while referring to the database to divide functions of the operation verification into a software function implemented by software and a hardware function implemented by hardware. The hardware function generates a test pattern and inputs the test pattern to the device under test to perform the operation verification. The hardware function is controllable by changing a control parameter. The software function variably sets the control parameter. The circuit operation verification method further includes: (c) generating a software execution data that is executed by a computer to provide the software function; and (d) generating a configuration data that configures the hardware function and the device under test in a programmable logic device. The circuit operation verification method further includes: (e) supplying the configuration data to the programmable logic device to configure the device under test and the hardware function in the programmable logic device; (f) operating the programmable logic device; and (g) executing, by the computer, the software execution data to variably set the control parameter.

According to the present invention, it is possible to achieve high-speed operation verification with respect to a semiconductor integrated circuit and to ensure flexibility and controllability for the operation verification.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a circuit operation verification system according to an embodiment of the present invention;

FIG. 2 is a block diagram showing an example of a test bench hardware section in the embodiment of the present invention;

FIG. 3 is a block diagram showing a configuration of a verification environment creation system according to the embodiment of the present invention;

FIG. 4 is a flow chart showing a verification environment creation processing and an operation verification processing according to the embodiment of the present invention;

FIG. 5 is a conceptual diagram showing a function component database and a scenario data in the embodiment of the present invention;

FIG. 6 is a conceptual diagram showing an example of the function component database and scenario data in the embodiment of the present invention;

FIG. 7 is a block diagram showing Step S20 in the embodiment of the present invention;

FIG. 8 shows an example of an address map in the embodiment of the present invention;

FIG. 9 shows an example of a scenario control section in a SW function data in the embodiment of the present invention;

FIG. 10 shows an example of a parameter setting section in the SW function data in the embodiment of the present invention;

FIG. 11 is a conceptual diagram showing an example of a HW function data in the embodiment of the present invention;

FIG. 12 is a block diagram showing Step S30 in the embodiment of the present invention; and

FIG. 13 is a block diagram showing Step S40 in the embodiment of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

1. Circuit Operation Verification System

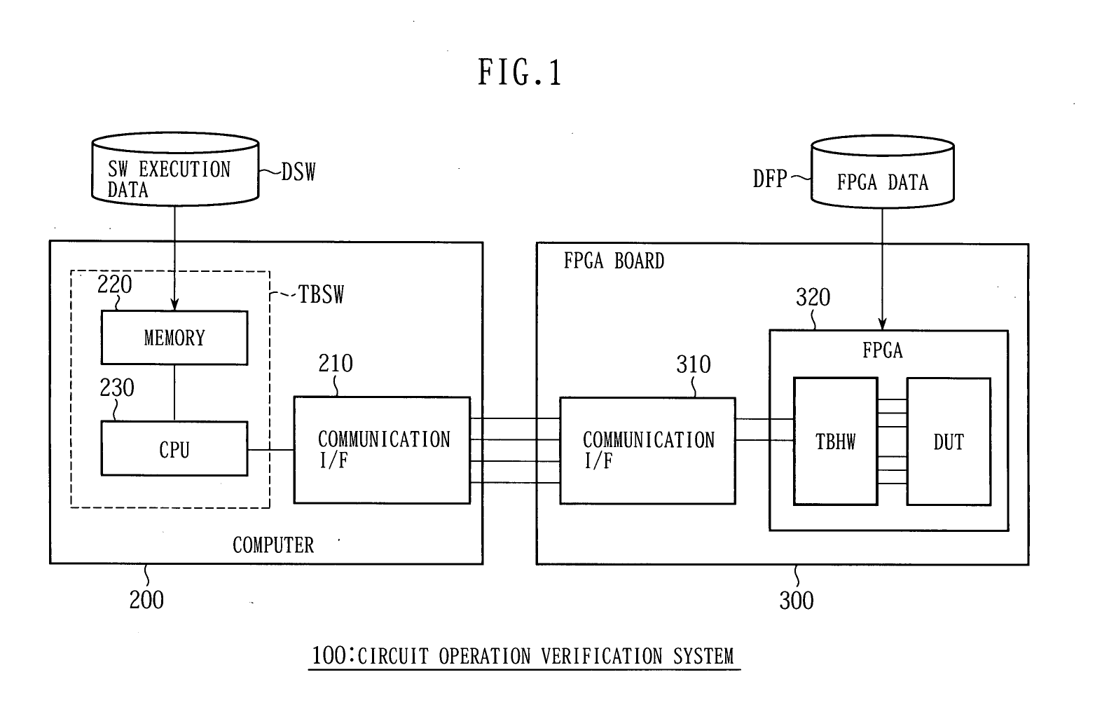

FIG. 1 is a block diagram showing a configuration of a circuit operation verification system 100 that performs operation verification of a device under test (DUT) in the present embodiment. The circuit operation verification system 100 is provided with a computer 200 and a programmable logic device (PLD: Programmable Logic Device). In the present embodiment, for example, an FPGA 320 is used as the programmable logic device.

The computer 200 has a communication interface 210, a memory 220 and a CPU (Central Processing Unit) 230. The communication interface 210 is a general-purpose interface such as a USB (Universal Serial Bus) and a PCI (Peripheral Component Interconnect).

A communication interface 310 and the FPGA 320 are mounted on an FPGA board 300. The communication interface 310 is a general-purpose interface such as a USB and a PCI. The communication interface 310 is connected to the FPGA 320 and the communication interface 210 of the computer 200. The DUT is configured (constructed) in the FPGA.

The circuit operation verification system 100 is further provided with a test bench section that performs the operation verification of the DUT. In the following description, “random verification” is considered as an example of the operation verification. In this case, the test bench section generates a random test pattern and inputs the random test pattern to the DUT to perform the random verification.

According to the present embodiment, the test bench section is configured by a combination of a test bench hardware section TBHW that is implemented by hardware and a test bench software section TBSW that is implemented by software.

The test bench hardware section TBHW being hardware is configured in the FPGA 320. That is, the DUT and the test bench hardware section TBHW are configured in the FPGA 320. More specifically, an FPGA data (configuration data) DFP for configuring the DUT and the test bench hardware section TBHW in the FPGA 320 is generated, and the FPGA data DFP is input to the FPGA 320. Thereby, the DUT and the test bench hardware section TBHW are configured (constructed) in the FPGA 320.

The test bench hardware section TBHW is connected to the DUT. A function of the test bench hardware section TBHW is to generate a random test pattern and perform the operation verification by inputting the random test pattern to the DUT. The function of the test bench hardware section TBHW is hereinafter referred to as a “hardware function”. Since generation and inputting of the random test pattern are executed by the hardware function on the FPGA, the random verification can be executed at high speed.

Meanwhile, the hardware function of the test bench hardware section TBHW depends on a control parameter and is controllable by changing the control parameter. For example, a random sequence of the random test pattern generated by the test bench hardware section TBHW can be changed by changing the control parameter. It is the test bench software section TBSW which sets up the control parameter.

The test bench software section TBSW is constructed on the computer 200. More specifically, the test bench software section TBSW is implemented by the computer 200 (CPU 230) executing software. A SW execution data DSW shown in FIG. 1 is an execution data of the software. The SW execution data DSW is loaded on the memory 220 and is executed by the CPU 230. Thereby, the test bench software section TBSW is implemented.

The test bench software section TBSW is communicably connected to the test bench hardware section TBHW through the communication interface 210 and the communication interface 310. The test bench software section TBSW is capable of supplying the above-described control parameter to the test bench hardware section TBHW through the communication interface. That is to say, the test bench software section TBSW is capable of variably setting the control parameter through the communication interface. Thereby, it is possible to ensure flexibility and controllability for the operation verification.

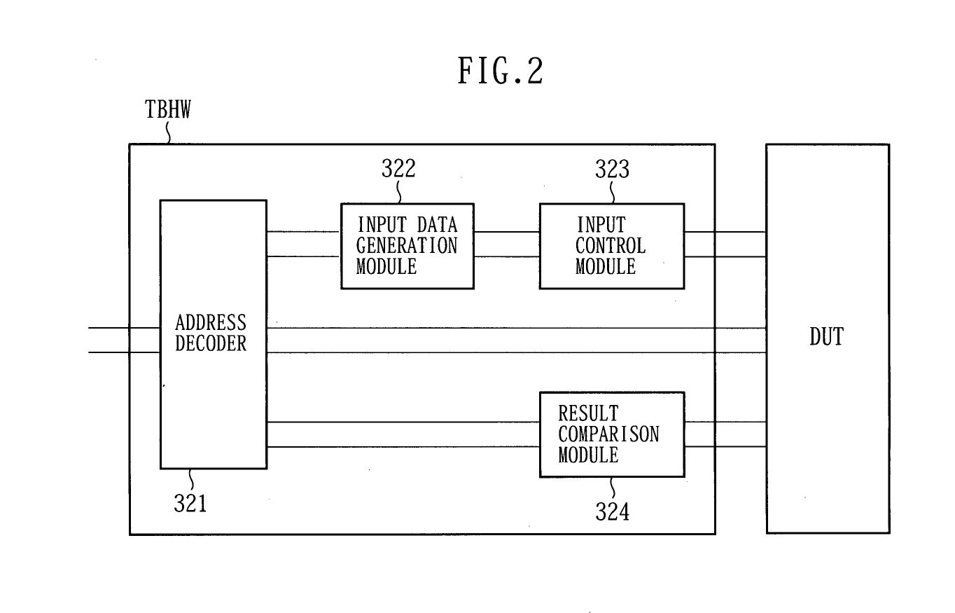

FIG. 2 shows an example of the test bench hardware section TBHW. In FIG. 2, the test bench hardware section TBHW has an address decoder 321, an input data generation module 322, an input control module 323 and a result comparison module 324.

The input data generation module 322 is a circuit that generates the random test pattern and includes, for example, a shift register. The input control module 323 is a circuit that inputs the random test pattern generated by the input data generation module 322 to the DUT. The result comparison module 324 is a circuit that generates a comparison value and makes a comparison between an output value from the DUT and the comparison value, and includes, for example, a CRC (Cyclic Redundancy Check) generation circuit. The address decoder (address memory) 321 is connected to respective circuits in accordance with an address map which will be described later. The test bench software section TBSW can supply the control parameter to each circuit through the address decoder 321.

For example, the DUT includes a scan chain and a scan test is possible. The test bench software section TBSW switches an operation mode of the DUT. The test bench hardware section TBHW inputs the random test pattern to the scan chain to perform the scan test. Then, a result of the scan test is fed back to the test bench software section TBSW. Based on the result of the scan test, the test bench software section TBSW changes the control parameter. For example, the test bench software section TBSW makes the input data generation module 322 generate another sequence of the random test pattern.

According to the present embodiment, as described above, generation and inputting of the test pattern are executed by the hardware function on the FPGA. In other words, all of the operation verification processing except for the parameter setup by the software side is executed by the hardware side. During the verification processing, no synchronizing processing occurs with respect to the computer 200. Therefore, high-speed operation verification is possible. Meanwhile, the control parameter such as the sequence of the generated test pattern is controllable by the software side on the computer 200. That is, it is possible to flexibly set the verification conditions such as the test pattern and the scenario. In this manner, according to the present embodiment, it is possible to achieve high-speed operation verification with respect to a semiconductor integrated circuit and to ensure the flexibility and the controllability for the operation verification.

2. Creation of Operation Verification Environment

Next, a method of generating the above-mentioned SW execution data DSW and FPGA data DFP to create an operation verification environment will be described in detail.

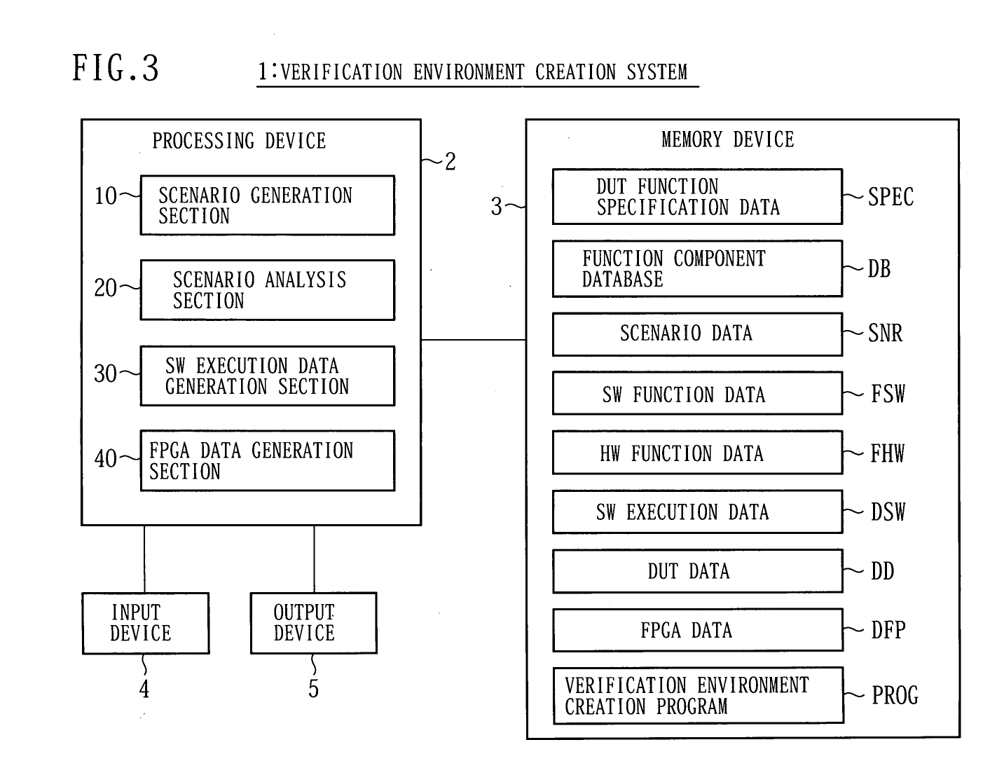

FIG. 3 shows a configuration of a “verification environment creation system 1” that generates the SW execution data DSW and the FPGA data DFP to create the operation verification environment. The verification environment creation system 1 is a computer system and has a processing device 2, a memory device 3, an input device 4 and an output device 5. The processing device 2 includes a CPU. The memory device 3 is exemplified by a RAM and a HDD. The input device 4 is exemplified by a key board and a mouse. The output device 5 is exemplified by a display.

Stored in the memory device 3 are a DUT function specification data SPEC, a function component database DB, a scenario data SNR, a SW function data FSW, a HW function data FHW, the SW execution data DSW, a DUT data DD, the FPGA data DFP and the like. Details of the respective data will be described later.

The processing device 2 has function blocks such as a scenario generation section 10, a scenario analysis section 20, a SW execution data generation section 30, an FPGA data generation section 40 and the like. These function blocks are typically implemented by the processing device 2 executing a verification environment creation program PROG. The verification environment creation program PROG is a computer program executed by the verification environment creation system 1 (processing device 2) and is stored in the memory device 3. The verification environment creation program PROG may be recorded on a computer-readable recording medium.

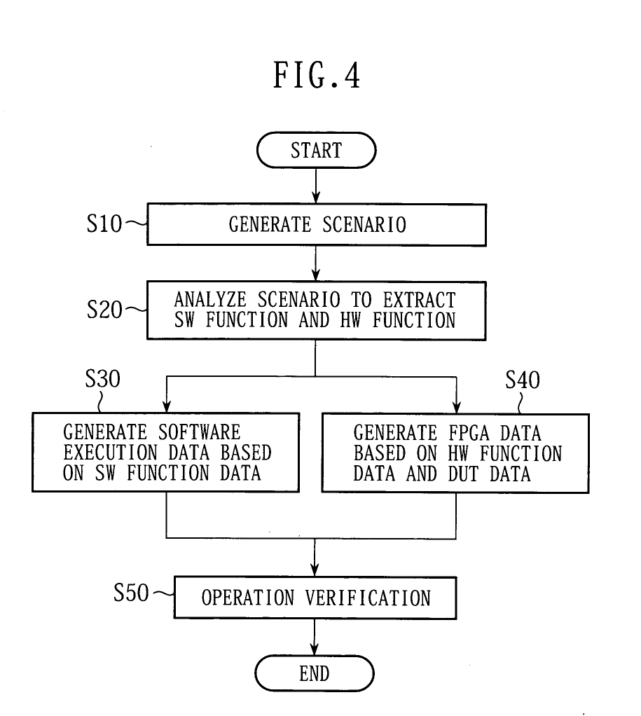

FIG. 4 is a flow chart showing a verification environment creation processing and an operation verification processing according to the present embodiment. The verification environment creation processing according to the present embodiment will be described below in detail. Here, let us consider a case where the operation verification is the random verification.

2-1. Step S10: Generation of Scenario

The scenario generation section 10 generates the scenario data SNR indicating a scenario of the operation verification and stores the scenario data SNR in the memory device 3. On generating the scenario data SNR, the scenario generation section 10 refers to the DUT function specification data SPEC and the function component database DB stored in the memory device 3. The DUT function specification data SPEC indicates a function specification of the DUT as the verification target (object). The function component database DB is a database in which various verification functions necessary for the random verification are defined. The scenario generation section 10 selects, through dialogue with a user, necessary verification functions and incorporates them into the scenario.

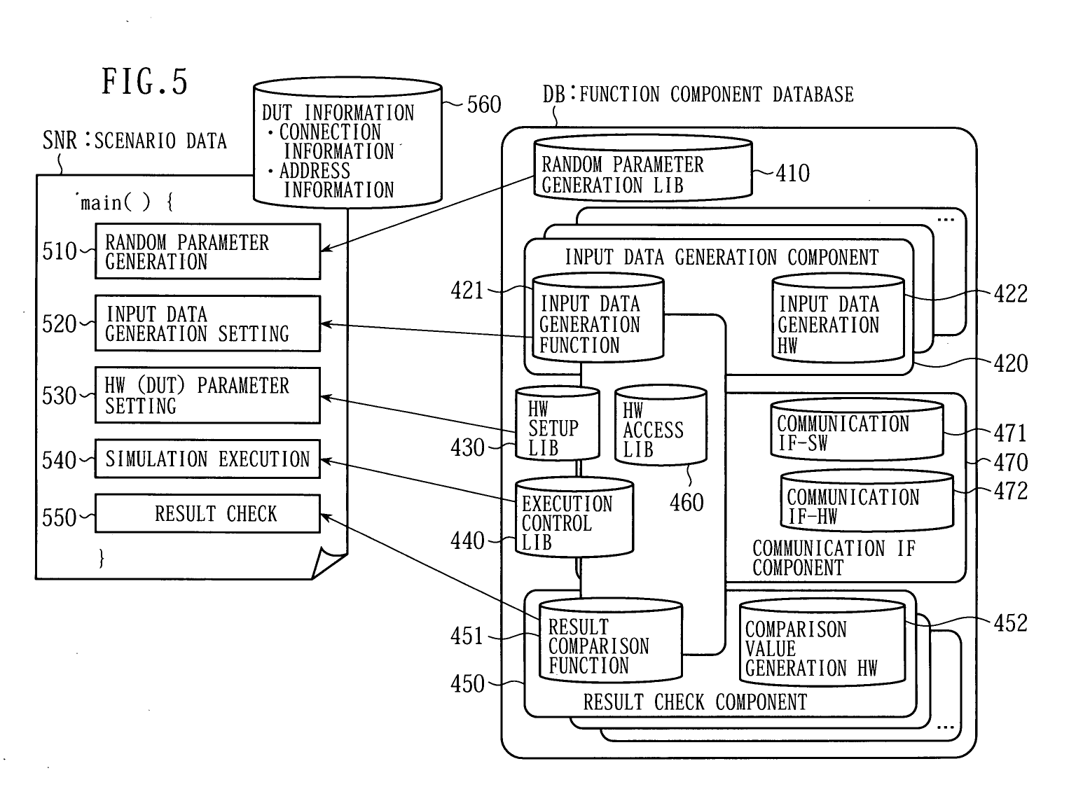

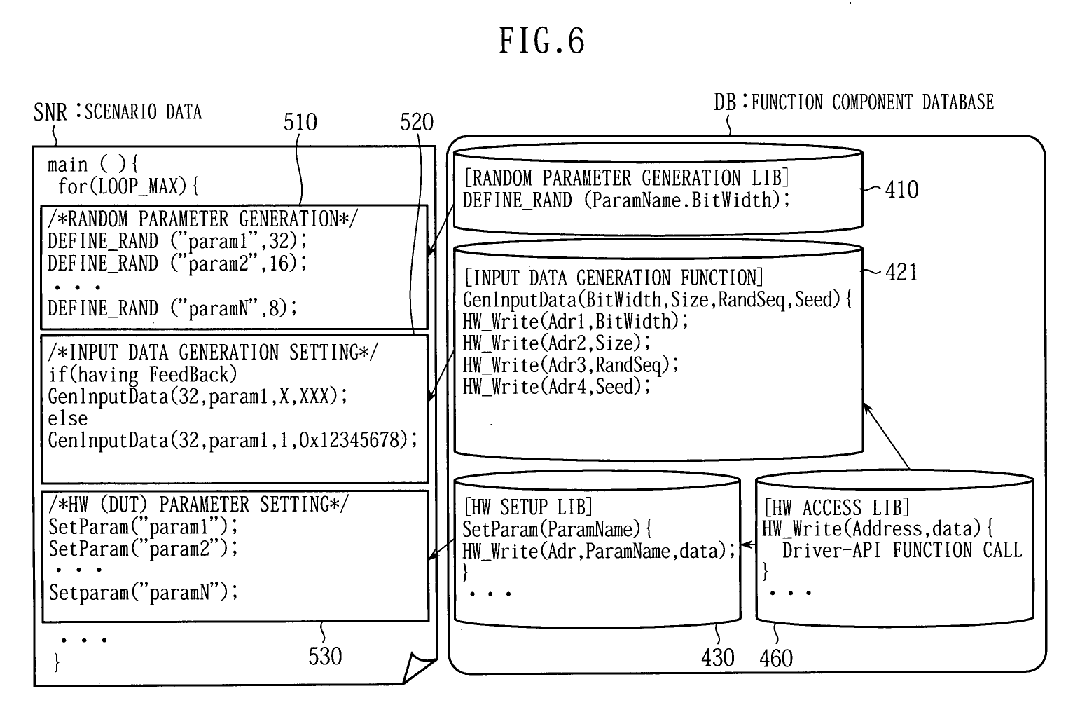

FIG. 5 conceptually shows the function component database DB and the scenario data SNR. FIG. 6 shows an example of the function component database DB and the scenario data SNR.

2-1-1. Function Component Database DB

In the function component database DB, function components that are used in common in each random verification are defined as functions and libraries. Moreover, function component hardware and function component software associated with the function components also are defined. It should be noted that a parameter of the function component hardware can be set by software. First, an example of various functions, libraries, function component hardware and function component software included in the function component database DB is described with reference to FIGS. 5 and 6.

<Random Parameter Generation Library 410>

The random parameter generation library 410 is expressed, for example, as DEFINE_RAND (ParamName, BitWidth). The random parameter generation library 410 defines a variable (ParamName) and generates a random value with a specified bit width (BitWidth).

<Input Data Generation Component 420>

The input data generation component 420 includes an input data generation function 421 and input data generation hardware 422. The input data generation function 421 generates the random test pattern which is to be input to the DUT. For example, the input data generation function 421 is expressed as GenInputData (BitWidth, Size, RandSeq, Seed). Here, “BitWidth” indicates a data width, “Size” indicates a size, “RandSeq” indicates the random sequence, and “Seed” indicates a random seed. The input data generation hardware 422 is function component hardware that is associated with the input data generation function 421. The input data generation hardware 422 is, for example, a shift register.

<HW Setup Library 430>

The HW setup library 430 is expressed, for example, as SetParam (ParamName). The HW setup library 430 sets a data in a specified variable (ParamName).

<Execution Control Library 440>

The execution control library 440 executes a simulation.

<Result Check Component 450>

The result check component 450 includes a result comparison function 451 and comparison value generation hardware 452. The result comparison function 451 checks a result of the operation verification. The comparison value generation hardware 452 is function component hardware which is related to the result comparison function 451. The comparison value generation hardware 452 is, for example, a CRC generation circuit.

<HW Access Library 460>

The HW access library 460 is expressed, for example, as HW_Write (Address, data). The HW access library 460 writes a data (data) to a specified address (Address). The HW access library 460 is related to the input data generation function 421, the HW setup library 430, the execution control library 440, the result comparison function 451 and so forth.

<Communication IF Component 470>

The communication IF component 470 includes communication IF software 471 and communication IF hardware 472. The communication IF software 471 is software dedicated to the communication interface. The communication IF software 471 is exemplified by a driver API (Application Program Interface). The communication IF hardware 472 is hardware dedicated to the communication interface. The communication IF hardware 472 is exemplified by a PCI control hardware.

2-1-2. Scenario Data SNR

The scenario data SNR indicates the scenario of the operation verification. The scenario means what verifications are performed in what order. On generating the scenario data SNR, the scenario generation section 10 refers to the above-mentioned function component database DB. Then, the scenario generation section 10 selects, through dialogue with a user, necessary verification functions from the function component database DB and incorporates them into the scenario. That is, the scenario is described in a programming language by the use of the above-mentioned functions and libraries defined in the function component database DB. The scenario includes functions representing contents (functions) of desired operation verification. An example of the scenario will be described with reference to FIGS. 5 and 6.

<Random Parameter Generation Processing 510>

The random parameter generation processing 510 generates the random parameter. As shown in FIGS. 5 and 6, the random parameter generation processing 510 is described by the use of the above-mentioned random parameter generation library 410 in the function component database DB. For example, in FIG. 6, “param1” is the size.

<Input Data Generation Setting Processing 520>

The input data generation setting processing 520 generates the random test pattern that is to be input to the DUT. As shown in FIGS. 5 and 6, the input data generation setting processing 520 is described by the use of the above-mentioned input data generation function 421 in the function component database DB. For example, regarding GenInputData (32, param1, 1, 0x12345678) in FIG. 6, “32” is the data with (bit), “param1” is the size, “1” is the random sequence and “0x12345678” is the random seed. Moreover, regarding GenInputData (32, param1, X, XXX), the random sequence=“X” and the random seed=“XXX” are set to values in consideration of feedback. It should be noted that, as shown in FIG. 6, the HW access library 460 (HW_Write) is used for four times in the input data generation function 421. Therefore, the number of address usages in the input data generation setting processing 520 is four.

<HW (DUT) Parameter Setting Processing 530>

The HW (DUT) parameter setting processing 530 sets up the parameters of the DUT. As shown in FIGS. 5 and 6, the HW (DUT) parameter setting processing 530 is described by the use of the above-mentioned HW setup library 430 in the function component database DB. It should be noted that, as shown in FIG. 6, the HW access library 460 (HW_Write) is used for one time in the HW setup library 430. Moreover, in the HW (DUT) parameter setting processing 530, the HW setup library 430 (SetParam) is used for N times. Therefore, the number of address usages in the HW (DUT) parameter setting processing 530 is N.

<Simulation Execution Processing 540>

The simulation execution processing 540 executes a simulation. As shown in FIG. 5, the simulation execution processing 540 is described by the use of the above-mentioned execution control library 440 in the function component database DB.

<Result Check Processing 550>

The result check processing 550 checks a result of the operation verification. As shown in FIG. 5, the result check processing 550 is described by the use of the above-mentioned result comparison function 451 in the function component database DB.

It should be noted that the scenario data SNR includes DUT information 560 (connection information, address information) as well.

2-2. Step S20: Scenario Analysis

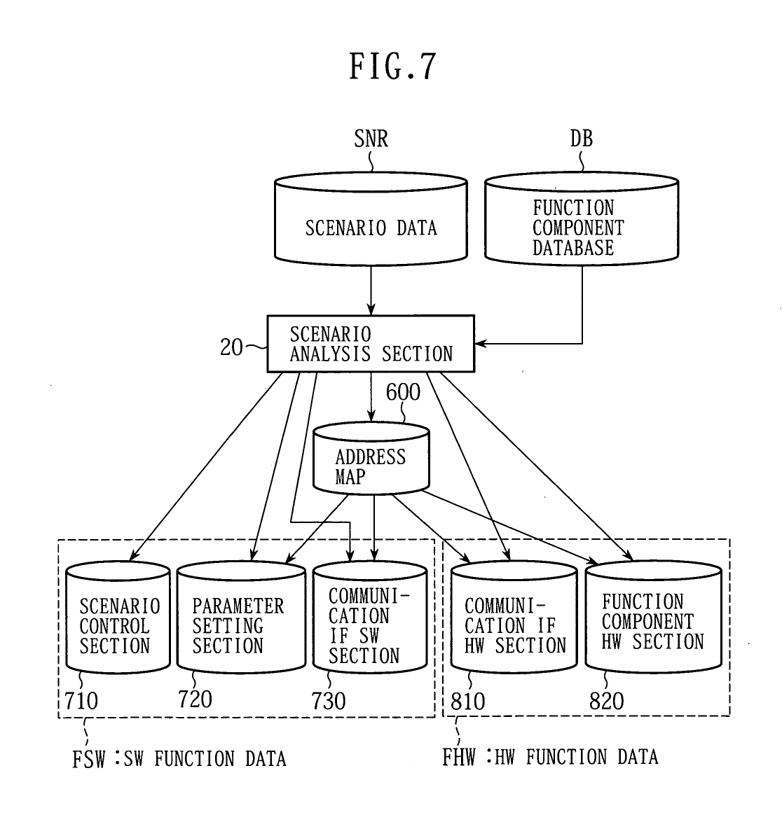

FIG. 7 shows Step S20. In Step S20, the scenario analysis section 20 reads the above-described scenario data SNR from the memory device 3. Then, the scenario analysis section 20 analyzes the function components included in the scenario while referring to the function component database DB. Thereby, the scenario analysis section 20 divides the functions of the operation verification indicated by the scenario into the software function that is implemented by software and the hardware function that can be implemented by hardware.

As described above, the hardware function generates the random test pattern and inputs the random test pattern to the DUT to perform the random verification. The hardware function depends on the control parameter and is controllable by changing the control parameter. The software function variably sets the control parameter. The scenario analysis section 20 analyzes the scenario to extract the software function and the hardware function and generate the SW function data FSW and the HW function data FHW indicating the respective functions. The SW function data FSW and the HW function data FHW are stored in the memory device 3.

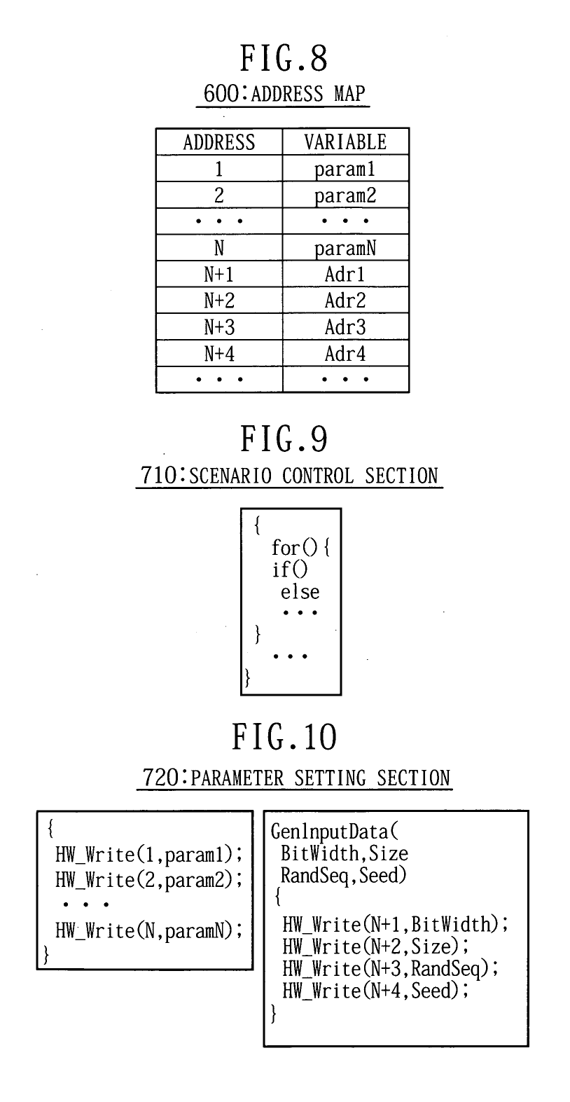

More specifically, the scenario analysis section 20 first generates an address map 600. FIG. 8 shows the address map 600 that is generated in the case of the example shown in FIG. 6. As described above, the number of address usages in the input data generation setting processing 520 is four, and the number of address usages in the HW (DUT) parameter setting processing 530 is N. The scenario analysis section 20 appropriately calculates offset values based on the number of address usages of each processing (function component) included in the scenario to generate the address map 600. As a result, in the example shown in FIGS. 6 and 8, the variables “param1” to “paramN” used in the HW (DUT) parameter setting processing 530 are respectively mapped to addresses 1 to N, and the variables “Adr1” to “Adr4” used in the input data generation setting processing 520 (input data generation function 421) are respectively mapped to addresses N+1 to N+4.

The scenario analysis section 20 generates the SW function data FSW based on the address map 600, the scenario data SNR and the function component database DB. As shown in FIG. 7, the SW function data FSW includes a scenario control section 710, a parameter setting section 720 and a communication IF software section 730.

The scenario control section 710 corresponds to a scenario sequence extracted from the scenario data SNR. FIG. 9 shows the scenario control section 710 in the case of the example shown in FIG. 6. The parameter setting section 720 sets various kinds of control parameters of the test bench hardware section TBHW and the DUT. FIG. 10 shows the parameter setting section 720 in the case of the example shown in FIG. 6, which corresponds to the input data generation setting processing 520 and the HW (DUT) parameter setting processing 530 indicated by the scenario data SNR. As shown in FIG. 10, the address information indicated by the address map 600 is reflected in the parameter setting section 720. The communication IF software section 730 is generated from the DUT information 560 (address information), the address map 600 and the communication IF software 471 in the function component database DB.

Moreover, the scenario analysis section 20 generates the HW function data FHW based on the address map 600, the scenario data SNR and the function component database DB. As shown in FIG. 7, the HW function data FHW includes a communication IF hardware section 810 and a function component hardware section 820. The communication IF hardware section 810 is generated from the DUT information 560 (address information), the address map 600 and the communication IF hardware 472 in the function component database DB. The function component hardware section 820 is generated by combining the function component hardware (the input data generation hardware 422, comparison value generation hardware 452, and so forth) associated with each function component used in the scenario with the DUT information 560 (address information, connection information).

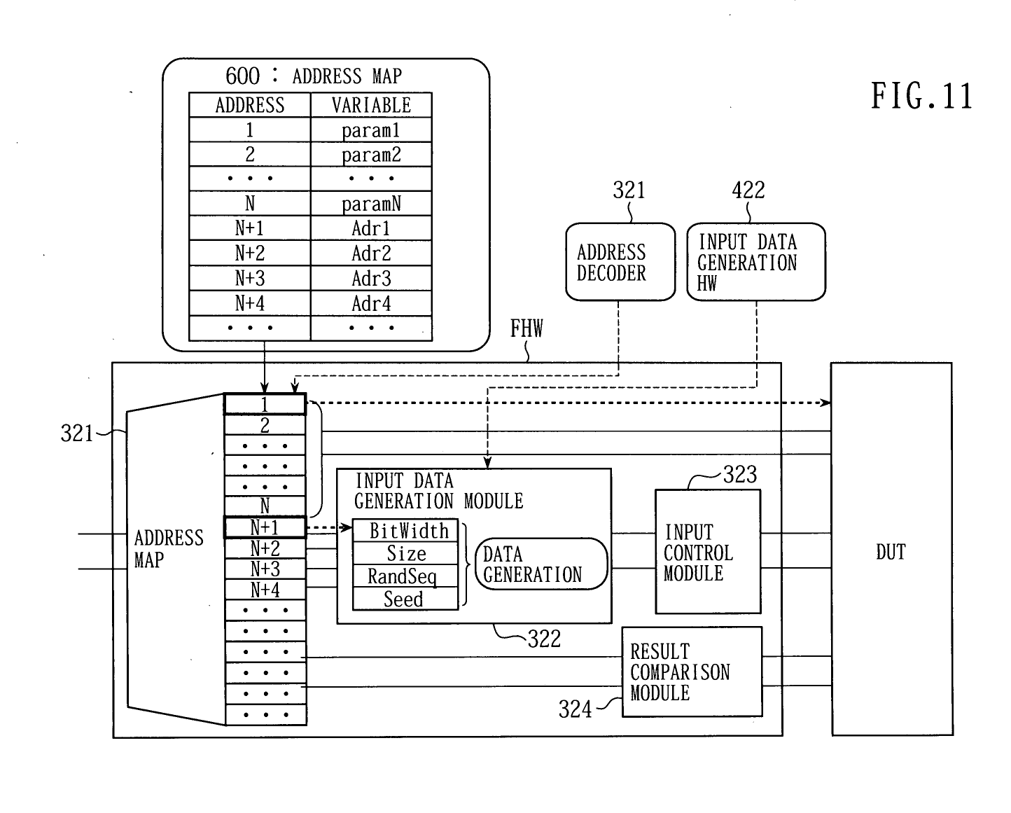

FIG. 11 conceptually shows an example of the HW function data FHW and corresponds to the circuit shown in the foregoing FIG. 2. The function component hardware associated with the function component used in the scenario is connected to the DUT and other function component hardware, in accordance with the scenario. For example, the input data generation module 322 associated with the input data generation hardware 422 is connected to the address decoder 321. The input data generation module 322 generates the random test pattern depending on the control parameters (BitWidth, Size, RandSeq, Seed). The control parameters can be controlled by the software side (input data generation setting processing 520) through the address decoder 321 (address map 600). It is possible to read and write values from the software side by accessing to the separately mapped addresses.

2-3. Step S30: Generation of SW Execution Data

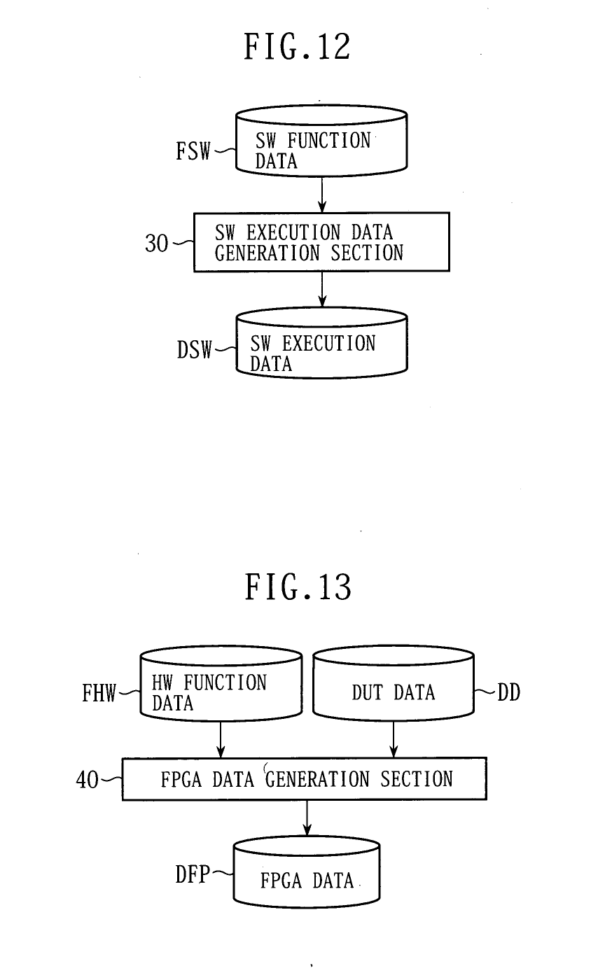

FIG. 12 shows Step S30. In the Step S30, the SW execution data generation section 30 reads the SW function data FSW from the memory device 3 and converts the SW function data FSW into the SW execution data DSW. As shown in FIG. 1, the SW execution data DSW is executed by the computer 200 to provide the above-described software function, at the time of the operation verification. The generated SW execution data DSW is stored in the memory device 3.

2-4. Step S40: Generation of FPGA Data

FIG. 13 shows Step S40. In the Step S40, the FPGA data generation section 40 reads the HW function data FHW and the DUT data DD from the memory device 3. The DUT data DD indicates designed functions of the DUT. The FPGA data generation section 40 generates the FPGA data DFP by performing logic synthesis processing and placement/routing processing with respect to the HW function data FHW and the DUT data DD. As described above, the FPGA data DFP is a configuration data used for configuring the DUT and the hardware function in the FPGA 320. The generated FPGA data DFP is stored in the memory device 3.

2-5. Step S50: Operation Verification Processing

When the SW execution data DSW and the FPGA data DFP are prepared in this manner, the operation verification shown in FIG. 1 becomes possible. First, the FPGA data DFP is supplied to the FPGA 320, and thereby the DUT and the test bench hardware section TBHW are configured (constructed) in the FPGA 320. Next, the FPGA 320 is operated. Moreover, the computer 200 executes the SW execution data DSW to variably set the control parameter. In this manner, the operation verification processing according to the present embodiment is achieved.

It is apparent that the present invention is not limited to the above embodiments and may be modified and changed without departing from the scope and spirit of the invention.

What is claimed is:

1. A circuit operation verification system comprising:
a computer;
a programmable logic device in which a device under test is configured; and
a test bench section configured to perform operation verification of said device under test,
wherein said test bench section comprises:
a software section that is implemented by said computer executing software; and
a hardware section configured in said programmable logic device together with said device under test,
wherein said hardware section has a hardware function that generates a test pattern and inputs said test pattern to said device under test to perform said operation verification,
said hardware function is controllable by changing a control parameter, and
said software section variably sets said control parameter.

2. The circuit operation verification system according to claim 1,
wherein said test pattern is a random test pattern, and
said operation verification is random verification.

3. A verification environment creation method for creating an environment for operation verification of a device under test,
said verification environment creation method comprising:
reading a scenario data indicating a scenario of said operation verification from a memory device,
wherein said scenario is described in a programming language and includes a function representing contents of said operation verification, and
said function and associated hardware are defined in a database;
analyzing said scenario while referring to said database to divide functions of said operation verification into a software function implemented by software and a hardware function implemented by a hardware,
wherein said hardware function generates a test pattern and inputs said test pattern to said device under test to perform said operation verification,
said hardware function is controllable by changing a control parameter, and
said software function variably sets said control parameter;
generating a software execution data that is executed by a computer to provide said software function; and
generating a configuration data that configures said hardware function and said device under test in a programmable logic device.

4. The verification environment creation method according to claim 3,
wherein said test pattern is a random test pattern, and
said operation verification is random verification.

5. A verification environment creation program recorded on a computer-readable medium that, when executed, causes a computer to perform the verification environment creation method according to claim 3.

6. A circuit operation verification method for performing operation verification of a device under test,
said circuit operation verification method comprising:
reading a scenario data indicating a scenario of said operation verification from a memory device,
wherein said scenario is described in a programming language and includes a function representing contents of said operation verification, and
said function and associated hardware are defined in a database;
analyzing said scenario while referring to said database to divide functions of said operation verification into a software function implemented by software and a hardware function implemented by a hardware,
wherein said hardware function generates a test pattern and inputs said test pattern to said device under test to perform said operation verification,
said hardware function is controllable by changing a control parameter, and
said software function variably sets said control parameter;
generating a software execution data that is executed by a computer to provide said software function;
generating a configuration data that configures said hardware function and said device under test in a programmable logic device;
supplying said configuration data to said programmable logic device to configure said device under test and said hardware function in said programmable logic device;
operating said programmable logic device; and
executing, by said computer, said software execution data to variably set said control parameter.
